(19) United States
(12) Patent Application Publication
(10) Pub. No.: US 2006/0236144 A1
(43) Pub. Date: Oct. 19, 2006

(54) Method for saving power of a laptop computer

(75) Inventor: Shu-Lin Chao, Taipei Hsien (TW)

Correspondence Address: BRUCE TROXELL, SUITE 1404, 5205 LEESBURG PIKE, FALLS CHURCH, VA, 22041, US

(73) Assignee: Wistron Corp.

(21) Appl. No.: 11/171,395

(22) Filed: Jul. 1, 2005

(30) Foreign Application Priority Data
Apr. 18, 2005 (TW) 094112314

(51) Int. Cl. G06F 1/00

(52) U.S. Cl. 713/323

(57) ABSTRACT

A method for saving power of a laptop computer is capable of reducing brightness of the display automatically based on battery capacity to save power and extend life span of the battery under a condition of not influencing the user so as to enhance competition of product.

### BACKGROUND OF THE INVENTION

1. Field of the Invention

The present invention is related to a method for saving power of a computer and particularly to a method for saving power of a laptop computer.

2. Brief Description of Related Art

An ordinary desktop computer or a laptop computer provides a power saving mode to economize energy or save on power consumption and life span of a laptop computer.

There are a number of technique to perform power saving for a computer. For instance, U.S. Pat. No. 6,874,091 discloses low power consumption computer peripheral device and method for reducing power consumption; U.S. Pat. No. 5,954,820 discloses portable computer with adaptive demand-driven power management; U.S. Pat. No. 5,845,291 discloses computer with reduced power consumption; and U.S. Pat. No. 5,767,594 discloses computer keyboard power saving method.

Life span of the battery is an important item for quality evaluation of laptop computer design and always a significant subject that has to be cared. It is known that the liquid crystal display (LCD) is one of components consuming power very much such that it affects life span of the battery tremendously. If brightness of the LCD can be controlled effectively, power could be saved substantively and the life span of the battery could be extended advantageously. Accordingly, competition of product is capable of being enhanced.

### SUMMARY OF THE INVENTION

The crux of the present invention is to economize energy and extend the life span of the battery by way of controlling brightness of the LCD.

An object of the present invention is to provide a method for saving power of a laptop computer for reducing brightness of the LCD automatically based on battery capacity so that power can be saved and life span of the battery can be extended under a condition of not influencing the user.

Another object of the present invention is to provide a method for saving power of a laptop computer, which is capable of economizing power effectively and extending life span of the battery, for enhancing product competition.

Therefore, a method for saving power of a laptop computer according to the present invention is capable of reducing brightness of the LCD automatically based on battery capacity to save power and extend life span of the battery under a condition of not influencing the user so as to enhance competition of product.

### BRIEF DESCRIPTION OF THE DRAWINGS

The present invention can be more fully understood by reference to the following description and accompanying drawings, in which:

FIG. 1 is a block diagram of the first hardware structure of a method for saving power of a laptop computer according to the present invention;

FIG. 2 is a block diagram of the second hardware structure of a method for saving power of a laptop computer according to the present invention;

FIG. 3 is a flow chart of the first embodiment of a method for saving power of a laptop computer according to the present invention;

FIG. 4 is a flow chart of the second embodiment of a method for saving power of a laptop computer according to the present invention;

FIGS. 5A to 5C are graphs indicating relations between battery capacity and brightness while the embodiments are implemented.

### DETAILED DESCRIPTION OF THE INVENTION

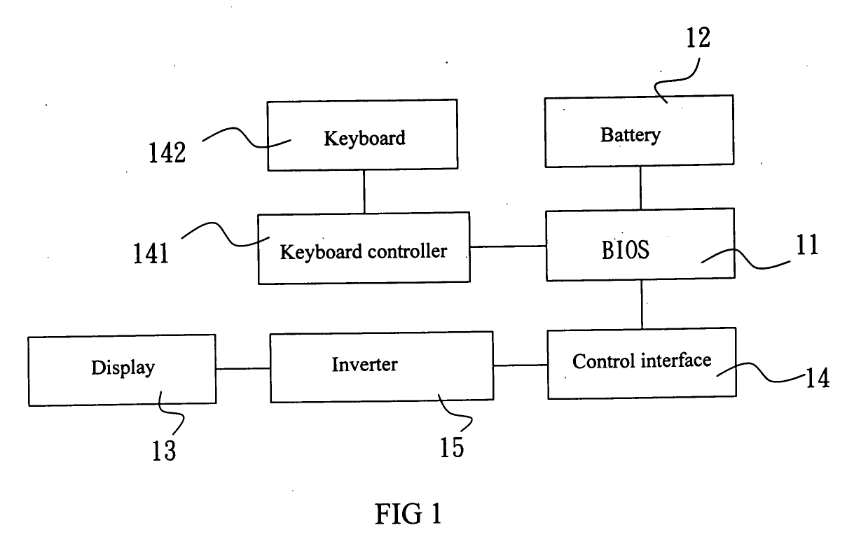

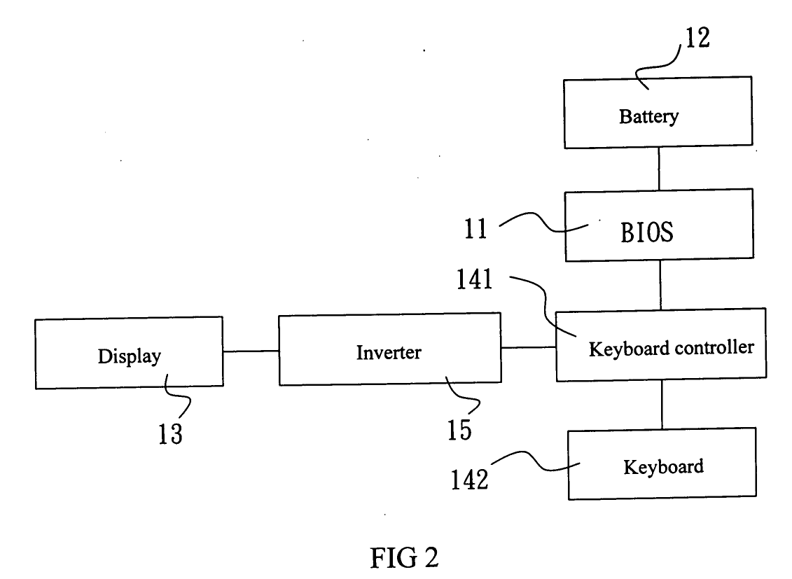

Referring to FIGS. 1 and 2, the BIOS (Basic Input/Output System) 11 of an ordinary laptop computer instantly detects message related to battery capacity offering from a chip inside the battery 12 and the message related to the battery capacity is shown on the display window of the display 13 via the operation system for the user being kept informed the capacity of the battery. Usually, brightness of the display 13 is controlled by way of an instruction being sent to a control interface 14 by BIOS 11 to allow the control interface 14 outputting a lower voltage and the lower voltage being amplified as a high voltage via an inverter 15 such that the high voltage driving the display 13 to emit light. The brightness of the display 13 is related to magnitude of the driving voltage, that is, higher driving voltage provides brighter display 13 with high power consumption. The control interface 14 can be North Bridge chip or a keyboard controller (KBC) 141 as shown in FIG. 2.

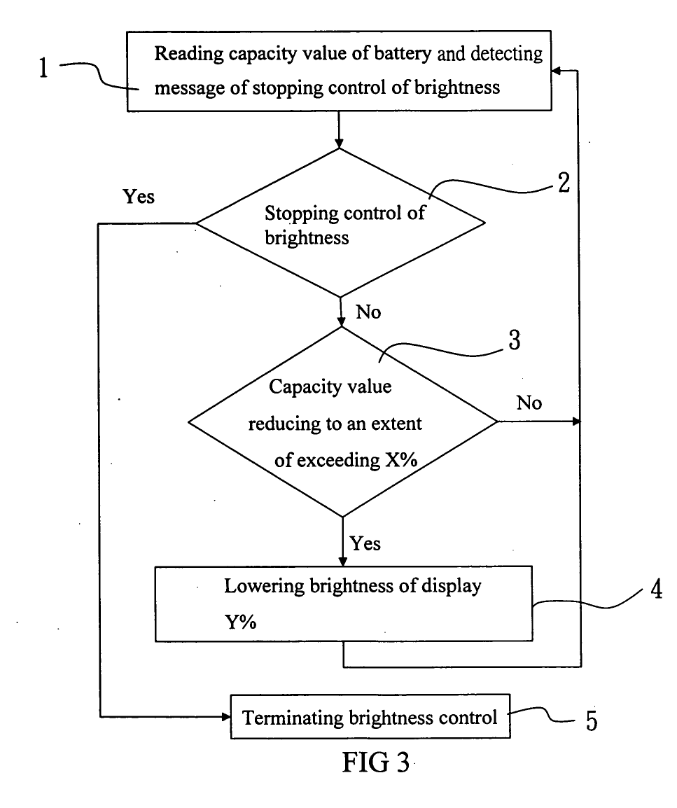

Referring to FIG. 3, a method for saving the power of a laptop computer according to the present invention is capable of reducing brightness of LCD automatically based on battery capacity to save power and extend life span of the battery under a condition of not influencing the user. The first embodiment of the method of saving power for a laptop computer disclosed in the present invention includes the following steps:

(1) The BIOS of the laptop computer reads the capacity value of the battery and detects if there is message of aborting control of brightness;

(2) Enter step (5) when the BIOS detects a hot key being pressed and sends out message of stopping control of brightness, otherwise, enter next step;

(3) Compare the current capacity value of battery to the previously read capacity value of the battery and enter next step in case of the capacity value of battery reducing to an extent of exceeding X %, otherwise, returns to step (1);

(4) The BIOS issues a control instruction to reduce driving voltage output from the inverter and then return to step (1) after brightness of the display reduces Y %;

(5) Terminate operation of brightness control.

The hot key can be a key on a keyboard 142 as shown in FIGS. 1 and 2. Once the BIOS 11 detects and finds out a message from a keyboard controller 141 that the hot key of the keyboard 142 has been pressed, the control operation to brightness of the display 13 is terminated.

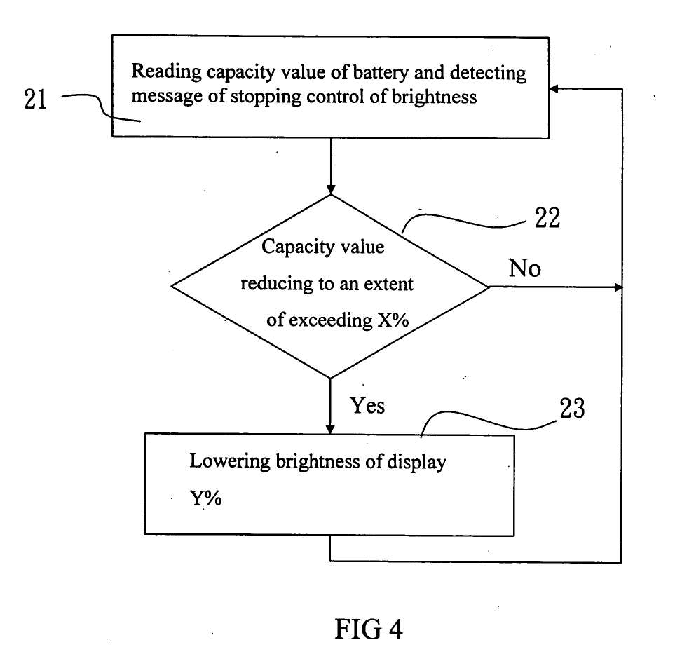

Referring to FIG. 4, the second embodiment of the method of saving the power of a laptop computer disclosed in the present invention provides no hot key to terminate control operation of brightness for the display and includes the following steps:

(11) The BIOS of the laptop computer reads the capacity value of the battery;

(22) Compare the current capacity value of battery to the a previously read capacity value of the battery and enter next step in case of reduction of the capacity value of battery exceeding X % below the previously read capacity value, otherwise, returns to step (21);

(23) The BIOS 11 issues a control instruction to reduce driving voltage output from the inverter and then return to step (1) after brightness of the display reduces Y %;

Referring to FIGS. 1 and 2 again, the BIOS sends out control signal to the control interface 14 according to instruction of control program to reduce voltage output to the inverter 15 once the current capacity of the battery 12 is detected to have a value lower than the original capacity thereof and difference between the current capacity and the original capacity exceeds X % of the original capacity such that driving voltage sent to the display 15 from the inverter 15 is reduced to diminish brightness of the display Y % of the original brightness. The control interface 14 can be a specific micro controller in addition to North Bridge chip or keyboard controller. X % and Y % indicate a certain percentage of value respectively.

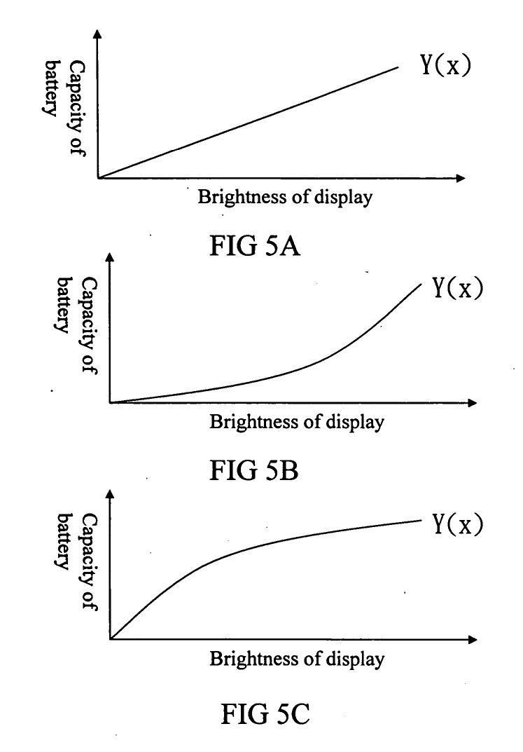

Referring to FIGS. 5A-5C, relationship between the capacity of battery and brightness of the display are illustrated. The capacity of battery can be reduced with equal proportion to brightness of the display as a linear relation shown in FIG. 5A or can be reduction rate being lower in case of the capacity of battery being more as a non-linear relation shown in FIG. 5B or can be reduction rate of brightness being higher in case of the capacity of battery being more as a non-linear relation shown in FIG. 5C.

The method for saving power of a laptop computer according to the present invention allows voltage supplying to the display of the laptop computer being reduced gradually so as to reduce brightness of the display under a condition of the user not noticing. As a result, the power is capable of saving effectively and extending life span of the battery.

Besides, control program of the BIOS allows the user to set comparison values for a battery capacity value via a software interface.

While the invention has been described with referencing to preferred embodiments thereof, it is to be understood that modifications or variations may be easily made without departing from the spirit of this invention, which is defined by the appended claims.

What is claimed is:

1. A method for saving the power of a laptop computer comprising following steps:
(1) the BIOS of the laptop computer reads the capacity value of a battery and detecting if there is an abort message of brightness control;
(2) terminating operation of brightness control once the BIOS has detected the abortmessage of brightness control, otherwise, entering next step;
(3) comparing the capacity of the battery to a previously read value of the capacity of the battery and proceeding to next step in the case of the capacity of battery drops below a certain percentage of the previously read value, otherwise, returning to step (1); and
(4) the BIOS issuing a control instruction to reduce the voltage output from an inverter, resulting the brightness of the display reduces to a certain percentage and then returning to step (1).

2. The method for saving the power of a laptop computer as defined in claim 1, wherein the message of stopping control of brightness in step (2) is sent out by way of a hot key being pressed.

3. The method for saving the power of a laptop computer as defined in claim 1, wherein step (2) further comprises that the BIOS issues control instruction to a control interface to reduce voltage output to the inverter so as to lower a driving voltage output to the display from the inverter.

4. The method for saving the power of a laptop computer as defined in claim 1, wherein the control interface is one of a North Bridge chip, a keyboard controller and a micro controller.

5. The method for saving the power of a laptop computer as defined in claim 1, wherein display is a liquid crystal display.

6. A method for saving the power of a laptop computer, comprising following steps:
(1) the BIOS of the laptop computer reads the capacity value of battery;
(2) comparing the capacity value of battery to a previous reading of the capacity of the battery and enter next step in the case of the capacity value of battery measured below to an extent of certain percentage, otherwise, returning to step (1); and
(3) the BIOS issuing a control instruction to reduce driving voltage output from an inverter and then return to step (1) after brightness of the display reduces to another certain percentage.

7. The method for saving the power of a laptop computer as defined in claim 6, wherein step (2) further comprises that the BIOS issues control instruction to a control interface to reduce voltage output to the inverter so as to lower a driving voltage output to the display from the inverter.

8. The method for saving the power of a laptop computer as defined in claim 6, wherein the control interface is one of a North Bridge chip, a keyboard controller and a micro controller.

9. The method for saving the power of a laptop computer as defined in claim 6, wherein display is a liquid crystal display.
